(19) United States
(12) Patent Application Publication
(10) Pub. No.: US 2006/0249638 A1
(43) Pub. Date: Nov. 9, 2006

(54) Removably attachable shower bar

(76) Inventor: Jim Ehrke, Paso Robles, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/416,690

(22) Filed: May 2, 2006

Related U.S. Application Data
(60) Provisional application No. 60/677,559, filed on May 3, 2005.

(51) Int. Cl. F16B 47/00; A45D 42/14

(52) U.S. Cl. 248/205.5

(57) ABSTRACT

A shower bar is provided for secure but removable attachment to a surface, such as a wall in a shower or bath area. The shower bar has a support bar connected to a pair of mechanically activated suction cup assemblies and a pivotal activator arm that operatively engages the suction cup assemblies to hold the shower bar to the surface of the wall or release it therefrom. The support bar has a channel that receives the activator arm therein when the shower bar is secured against the surface. Each of the suction cup assemblies has a cup housing that seals against a suction member to define a suction chamber in the cup housing. Pivot pins at the ends of the activator arm connect to activation rods that operatively engage the cup housing against the suction member. An arm release hole is provided to release the shower bar from the surface.

### CROSS-REFERENCE TO RELATED APPLICATIONS

This application claims the benefit of U.S. Provisional Patent Application No. 60/677,559 filed on May 3, 2005.

### BACKGROUND OF THE INVENTION

A. Field of the Invention

The field of the present invention relates generally to apparatuses and devices used for supporting clothes, wash clothes, towels or other objects in or near a shower or bath area. More specifically, this invention relates to such apparatuses and devices that are configured to removably but securely attach to a hard, non-porous wall or other generally smooth surface. Even more specifically, this invention relates to such apparatuses and devices that utilize one or more mechanically activated vacuum or suction cups to removably attach to the wall or other surface.

B. Background

The walls of most shower and bath areas are at least partially covered or otherwise provided with generally non-porous materials to protect the underlying wall from water that is splashed or sprayed during the shower or bath. In particular, due to the nature of the configuration of the shower head and spray therefrom, indoor shower areas nearly always have the walls covered with a substantially non-porous material to protect the drywall or other water damagable wall material underlying the covering material. Common materials utilized for shower walls include tile, marble, plastics (such as PVC and other plastics), fiberglass, glass and various composite materials. In addition to being substantially non-porous, shower walls are generally configured, for both aesthetics and comfort reasons, with a hard and relatively flat, smooth surface. While such surfaces are generally attractive and suitable for use as a shower enclosure, they are known to have certain limitations with regard to installing apparatuses or devices on the shower wall area. For instance, it is generally difficult to attach a hook, nail, screw or other attaching mechanism to or through the wall of a shower or bath area, as one normally does to other walls, due to the materials utilized for shower and bath enclosures. In addition to being difficult to accomplish, attempting to pass such an attaching mechanism to or through such walls risks cracking, chipping or otherwise damaging the wall. As a result, most people are unable or unwilling to utilize these attaching mechanisms to attach otherwise useful or necessary apparatuses or devices to their shower wall. If the shower or bath area is not in their own home, such as showers at gyms, hotels and the like, the user is neither allowed nor desirous to permanently attach an attaching mechanism to the surrounding or nearby wall.

One device that would be particularly useful for attachment to a shower wall is a bar type of apparatus which a person could use to hang a wash cloth or like objects inside the shower or bathing area or their towel, robe, clothes or the like at or nearby while taking a shower or bath. Instead, people generally have to hang these objects well outside the shower or bath area or over the shower door or low wall and hang the wash cloth over the shower head, soap dish or other projection inside the shower or bath area. Unfortunately, with regard to the placement of a towel in a shower area, particularly showers in gyms and the like, the area for hanging the towel is either out of easy reach or in an area where it is likely to get wet from the shower spray. Naturally, when it is out of reach it is also often out of the person's sight. When the person is done with the shower and desires to dry off, he or she usually has to either reach for the towel or have to step out of the shower enclosure while wet to get the towel and begin drying off. As a result, it would be useful to have an apparatus that is suitable for supporting a towel on a shower wall, particularly one that is removably attached so that it can be placed where desired and suitable for use in locations not belonging to the user, including showers in gyms, motels, hotels or rental units.

Although some manufactures texture the floor of the shower or the user utilizes a non-slip floor covering, which can provide some degree of resistance to slipping, the walls are nearly always left very smooth. In fact, most shower areas have very few, if any, non-plumbing projections into the shower area that can be used to stabilize a person. An exception to this are those showers that are primarily configured for disabled persons, which are typically provided with one or more fixedly attached shower bars to help support the disabled person while he or she is showering or getting in and out of the bath. However, as well known, the vast majority of shower enclosures are not provided with any type of support/stabilizing bar and, as discussed above, the materials used for shower enclosure makes it difficult to add a bar to the shower.

A variety of hook or hook-like devices are available for attachment to the shower wall which can, to some extent, be used for hanging a towel or like object inside a shower enclosure. Generally, these and other devices utilize a single suction cup that is configured to adhere to the wall by pushing the cup base against the wall, usually while it or the wall is wet. Some of these hook devices include a cam-type of locking mechanism that is configured to better secure the hook device to the wall. As is well known, however, these suction cup devices generally do not work very well and are typically not suitable for use with a bar that is intended to support much weight. For instance, such devices typically do not have enough suction or gripping strength to support the weight of the typical towel, robe or clothes and are not useful at all for stabilizing a person in the shower area. Even if the typical shower suction cups can initially support the weight of a towel, they generally lack sufficient suction power to maintain their attachment to the wall, particularly in light of the soap, water and steam which are present on shower enclosure walls.

In general, the use of mechanically activated suction cups as a gripping device to ease the handling of large pieces of glass, sheet metal, plastic, fiberglass, polished stone or like materials is well known. Typical, mechanically activated suction hand cups comprise a handle portion with a suction cup member that is activated by operating a lever to engage the suction cup against the material the user desires to lift or otherwise handle. Suction cup assemblies generally comprise a rubber suction cup member that is pressed against the material such that when the lever is activated a suction force is created between the suction cup and the material, thereby allowing the user to utilize the handle to lift or move the object to which the suction cup is now attached. To release the suction and disengage the object from the suction cup, the user moves the lever in the opposite direction. These devices are not configured for use as an object supporting bar in a shower or bath area.

What is needed, therefore, is a shower bar that is configured to be securely, yet removably attached to the typical wall surface utilized for shower and bath enclosures. The preferred shower bar apparatus should be configured to attach to a shower or bath wall with enough suction or gripping force to support a wash cloth, shower-sized towel, robe, clothes or other materials on the shower wall without slipping therefrom. The preferred shower bar apparatus will be easy to attach and remove from the shower wall surface. Preferably, the shower bar apparatus will be aesthetically pleasing and relatively inexpensive to manufacture.

### SUMMARY OF THE INVENTION

The removably attachable shower bar of the present invention provides the benefits and solves the problems identified above. That is to say, the present invention discloses a shower bar that is configured to be removably, but securely attached to the wall of a shower or bath enclosure to support a wash cloth, towel, robe, clothes or other materials in or near the shower or bath. The shower bar of the present invention can be easily attached and removed from various places in the shower or bath enclosure as determined by the user, such as inside the shower enclosure or on a wall next to the shower enclosure. The shower bar of the present invention provides sufficient attachment force that, if need be, it can help stabilize a person in the shower so as to prevent or check a person from slipping and falling in the enclosure, thereby reducing the likelihood the person will suffer severe or life-threatening injury from a fall. The shower bar of the present invention can be configured to have an aesthetically pleasing appearance and be relatively inexpensively manufactured.

In one general aspect of the present invention, the shower bar comprises a support bar, activator arm and one or more suction cup assemblies that cooperate together to attach to a surface, such as a wall of a shower or bath enclosure. In a preferred embodiment, the support bar has a first end section at a first end, a second end section at a second end and a center section that interconnects the first end section and the second end sections. The support bar has a channel, which in the preferred embodiment is downwardly directed, that receives the activator arm when the shower bar is attached to the surface. The first and second end sections are both disposed inwardly towards the surface of the tub or shower in order to dispose the center section of the support bar in a spaced apart relation to the surface. In one configuration, the support bar is configured in a substantially U-shape having a first end and a second end, at which are located the suction cup assemblies. The activator arm is in pivotal relation with the support bar such that the upward or downward movement thereof either engages or disengages the shower bar from the surface. Each of the suction cup assemblies have a cup housing, a suction member at an outwardly disposed open second end of the cup housing and a mechanism for disposing the cup housing against the suction member. The suction member, which generally will be made out of rubber or the like, is configured to sealably connect to the cup housing so as to define a suction chamber therein and securely attach the shower bar to the surface. In the preferred embodiment, the disposing mechanism comprises a pivot pin that interconnects the ends of the activator arm with one end of an activation rod. The other end of the activation rod is attached to the suction member. In one embodiment, a plate member interconnects the end of the activation rod and the suction member.

In operation, the user places the suction member against the surface at the location he or she desires to have a shower bar with the activator arm in the downward or disengaged position. To secure shower bar to the surface (i.e., shower wall), the user merely places activator arm in the engaged position by raising the activator arm upward into the support bar channel. The upward movement of the activator arm pushes the second end of the cup housing against the suction member and creates the suction force in the suction chamber to hold shower bar in place. To remove the shower bar, the user engages a releasing mechanism, which in a preferred embodiment comprising an arm release hole on the upper side of the support bar, by placing an elongate object into the arm release hole and pushing downward to initiate the downward motion of the activator arm. This downward motion displaces the second end of the cup housing away from the suction member and releases the shower bar from the surface.

Accordingly, the primary objective of the present invention is to provide a removably attachable shower bar that provides the advantages discussed above and overcomes the disadvantages and limitations associated with presently available shower wall attachment devices.

It is also an important objective of the present invention to provide a removably attachable shower bar that securely but removably attaches to the smooth, generally non-porous surfaces utilized in and around shower and bath areas.

It is also an important objective of the present invention to provide a removably attachable shower bar that sufficiently attaches to generally non-porous shower and bath walls to support the weight of a wash cloth, towel, robe, clothes and the like without slipping down or otherwise disengaging from the wall.

It is also an important objective of the present invention to provide a removably attachable shower bar that comprises a support bar which is integrally connected to a pair of mechanically activated suction cups and pivotal activator arm that is operatively connected to the suction cups so as to removably secure the bar to the wall of the shower or bath enclosure surface or release the suction cups therefrom.

It is also an objective of the present invention to provide a removably attachable shower bar that can be sufficiently attached to a shower wall to stabilize a person so as to prevent or slow a fall in the shower.

It is also an objective of the present invention to provide a removably attachable shower bar that has an aesthetically pleasing appearance and which can be manufactured relatively inexpensively.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a perspective view of the removably attachable shower bar configured according to the principles of a preferred embodiment of the present invention shown attached to a wall surface;

FIG. 2 is a cross-sectional top view of the removably attachable shower bar of FIG. 1 taken through the support bar showing the components of the activator arm, activation mechanism and suction cup assemblies;

FIG. 3 is a cross-sectional side view of the removably attachable shower bar of FIG. 1 taken through one of the suction cup assemblies showing the activator arm and activation mechanism in the disengaged position;

FIG. 4 is a bottom view of the support bar and integrally formed cup housing of a preferred embodiment of the removably attachable shower bar of the present invention;

FIG. 5 is a side view of a preferred configuration for the suction cup base used with the removably attachable shower bar of the present invention; and

FIG. 6 is a top view of a preferred configuration for the activator arm used with the removably attachable shower bar of the present invention.

### DETAILED DESCRIPTION OF THE PREFERRED EMBODIMENTS

With reference to the figures where like elements have been given like numerical designations to facilitate the reader's understanding of the shower bar of the present invention, the preferred embodiments of the present invention are set forth below. As will be recognized by those skilled in the art, the enclosed figures and drawings are merely illustrative of the preferred embodiments and represent several different ways of configuring the present invention. Although specific components, materials, configurations and uses are illustrated, it should be understood that a number of variations to the components and to the configuration of those components described herein and in the accompanying figures can be made without changing the scope and function of the invention set forth herein.

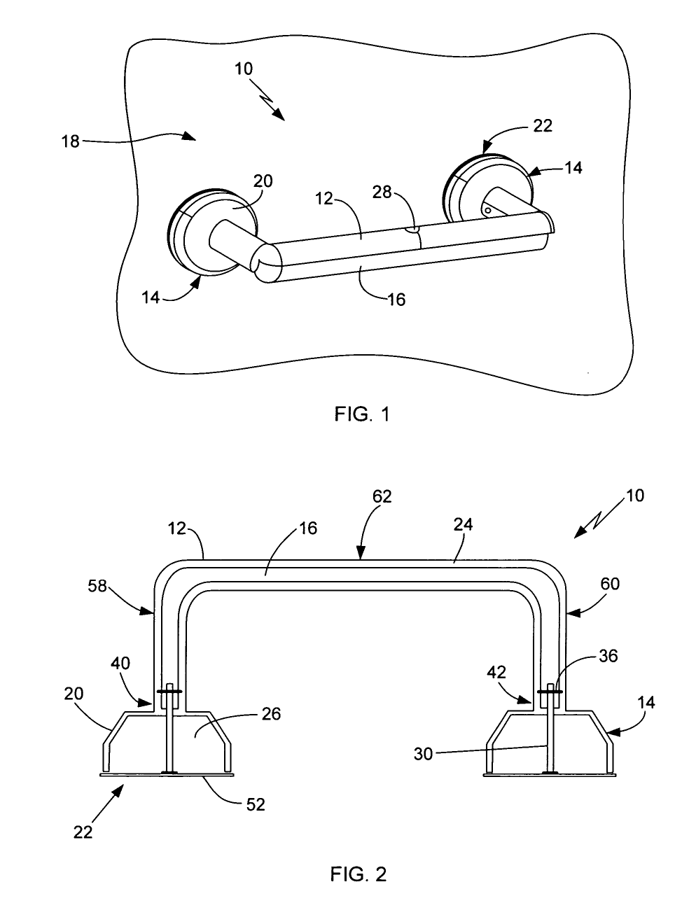

A removably attachable shower bar that is manufactured out of the materials and pursuant to one embodiment of the present invention is shown generally as 10 in FIGS. 1 through 3. As shown in these figures, shower bar 10 generally comprises a support bar 12, a pair of suction cup assemblies 14 and an activator arm 16 that are configured to securely, but removably attach shower bar 10 to a generally hard smooth surface, shown as 18 in FIG. 1, such as the walls of a shower or bath enclosure or the sides of a bathtub (as may be desired by the user). As described in more detail below, suction cup assemblies 14 are mechanically activated suction cups that are activated by the pivotally attached activator arm 16 so as to securely engage surface 18 and to provide an apparatus to support a wash cloth, towel, robe, clothes or other objects that may be accessed by a person utilizing the shower or bathtub. As shown in FIGS. 1 through 3, the suction cup assemblies 14 of the shower bar 10 of the present invention generally comprise cup housing 20 and cup base 22, which are configured to provide the suction force necessary to securely attach shower bar 10 to surface 18 so that the user can utilize shower bar 10 to support one or more objects. In the preferred embodiment, as shown in the figures, support bar 12 and cup housing 20 are integrally formed and configured from a sturdy material, such as molded plastic. The dimensions and configuration of the support bar 12 and cup assemblies 14 must be sufficient in length and circumference to provide the desired amount of suction against surface 18 and to provide the user with the desired amount of space to hang his or her objects (as described above).

As shown in FIG. 4, which is a view of the underside of a preferred embodiment of support bar 12 and cup housing 20, support bar 12 is formed with an open channel 24 for receiving activator arm 16 therein when shower bar 10 is secured to surface 18. In addition, cup housing 20 is formed with suction chamber 26 for housing the operating components of the cup assemblies 14. As explained in more detail below, support bar 12 has a release mechanism, such as arm release hole 28, that is configured to allow the user to initiate the downward movement of activator arm 16 so as to release shower bar 10 from surface 18. Although the preferred embodiment utilizes channel 24, primarily to provide a more unified and aesthetically pleasing shower bar 10, support bar 12 can be solid and activator arm 16 can be configured to abut against the underside of support bar 12 instead of inside channel 24.

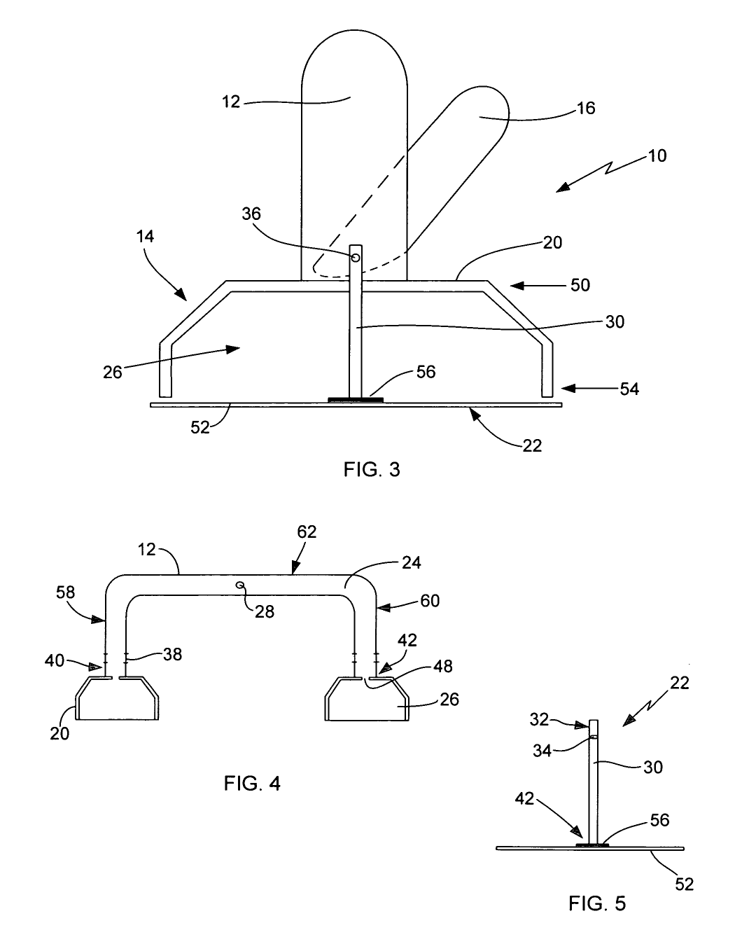

As shown in FIGS. 2 and 3, activator arm 16 is in pivotal relation with support bar 12 and cup base 22 operatively attaches to activator arm 16 by way of activation rod 30. The first end 32 of activation rod 30 is provided with a first activation rod hole 34 for receiving pivot pin 36 through a cooperatively configured second pivot pin hole 38 in the ends of support bar 12 near where it connects to cup housing 20 (as best shown in FIG. 4). Pivot pin 36 secures activation rod 30, and therefore cup base 22, to activator arm 16 in a manner that allows activator arm 16 to pivot between the engaged position shown in FIG. 1 to the disengaged or released position shown in FIG. 3. As shown in FIG. 2, which is a cross-section view of shower bar 10 through a position just above the center of suction cup assemblies 14, pivot pin 36 passes through the first end 40 and second end 42 of support bar 12 and first end 44 and second end 46 of activator arm 16 to obtain the pivotal relationship between support bar 12 and activator arm 16 necessary for the mechanical activation of suction cup assemblies 14. As best shown in FIGS. 2 and 4, activator rod 30 passes from suction chamber 26 of cup housing 20 to inside channel 24 for connection to pivot pin 36, which connects to activator arm 16, by way of a rod hole 48 at the first end 50 of cup housing 20. The second end 42 of activation rod 30 is attached to the suction member 52 at the second end 54 of cup housing 20, as best shown in FIG. 5. In a preferred embodiment, a plate member 56 interconnects the second end 42 of activation rod 30 with the suction member 52 of cup base 22. In the preferred embodiment, plate member 56 is a hard plastic material.

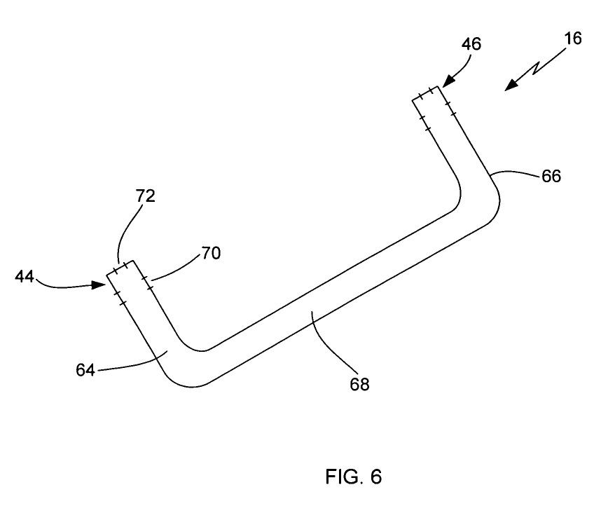

In the preferred embodiment, shown in the figures, shower bar 10 is configured in a generally U-shape with support bar 12 having a first end section 58 at first end 40, second end section 60 at second end 42 and center section 62 disposed between first 58 and second 60 end sections (as well as first 40 and second 42 ends), as best shown in FIG. 2. Support bar 12 is configured to dispose the center section 62 thereof in spaced apart relation to surface 18, as shown in FIG. 1, so the user may easily hang or otherwise place the objects over support bar 12. The first end 50 of cup housing 20 of each suction cup assembly 14 is attached to the first 40 and second 42 ends of support bar 12. In one preferred embodiment, shown in FIG. 4, cup housings 20 are integral with support bar 12. The suction member 52 of each suction cup assembly 14 is disposed at the second end 54 of cup housings 20, which are disposed outwardly from support bar 12, so as to define suction chamber 26 when suction member 52 is sealably connected or engaged with second end 54 of cup housings 20 (which occurs through the upward movement of activator arm 16 into channel 24 of support bar 12). As stated above, the mechanically activated suction cups for the shower bar 10 of the present invention comprises a mechanism for disposing the second end 54 of cup housings 20 against suction member 52 of each suction cup assembly 14. In the preferred embodiment, the suction cup assembly 14 disposing mechanism comprises the pivot pin 36 and activation rod 30, with the pivot pin 36 connecting the first end 32 of activation rod 30 to one end of activator arm 16 and the second end 42 of activation rod 30 connected to suction member 52, as best shown in FIGS. 2 and 3. In the preferred embodiment of the present invention, activator arm 16 is also configured in a generally U-shaped configuration, having a first end section 64 at first end 44, second end section 66 at second end 46 and a center section 68 disposed therebetween, as best shown in FIG. 6. The first 44 and second 46 ends of activator arm 16 have a third pivot pin hole 70 for receiving pivot pin 36 and an activation rod slot 72 for receiving activation rod 30 therethrough, as also best shown in FIG. 6. As best shown in FIG. 2, activation rod 30 passes through first 44 and second 46 ends of activator arm 16 and is attached to activator arm 16 by the insertion of pivot pin 36 through third pivot pin hole 70 and first activation rod hole 34.

In one exemplary embodiment, support bar 12 and cup housing 20 are made from an injection molded plastic. Although other dimensions can be used, in one embodiment support bar 12 is approximately eight to eighteen inches in width, cup housing 20 is approximately three and one-half inches in width and the distance from cup base 22 to the outside edge of support bar 12 is approximately four inches. Suction member 52 can be approximately three inches in diameter and one-eighth of an inch thick and be made out of a rubber or vinyl material. Activation rod 30 can be square, rectangular, round or other shapes. In one configuration, activation rod 30 is approximately one-half inch wide and one and three-fourths of an inch long with a one-fourth inch first pivot pin hole 34 for pivot pin 36. In use, suction member 52 is pressed against surface 18 at the location desired by the user with activator arm 16 in the downward or disengaged position shown in FIG. 3. Activator arm 16 is then pivotally raised from the position shown in FIG. 3 to the upward or engaged position shown in FIG. 1 (i.e., activator arm 16 disposed in channel 24 of support bar 12). As activator arm 16 pivots upward, it pulls activation rod 30 in the direction away from surface 18 and causes cup housing 20, by force from first 44 and second 46 ends of activator arm 16 against first end 50 of cup housing 20, to press against suction member 52 so as to create a substantial suction force against surface 18 to hold support bar 10 in place thereon. The action of suction member 52 against surface 18 tightly holds activator arm 16 in channel 24 of support bar 12. When the user desires to remove shower bar 10 from surface 18 or move it to another location, he or she merely pushes an elongated member through arm release hole 28 against activator arm 16 to initiate a pivotal downward movement of activator arm 16. As activator arm 16 pivots downward, it pushes activation rod 30 towards surface 18, causing suction member 52 to release the suction against surface 18. If desired, shower bar 10 can be provided with a quick release button or other mechanism that the user pushes to initiate the downward movement of activator arm 16 to disengage shower bar 10. When released, shower bar 10 can be removed or moved to another location, where it can be attached to the new surface as described above.

While there are shown and described herein a specific embodiment of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are components described herein that can be replaced with equivalent functioning components to accomplish the objectives of the present invention. One such modification is the use of different materials than those set forth herein.

What is claimed is:

1. A shower bar for removable attachment to a surface, said shower bar comprising:
a support bar having a first end, a second end and a center section disposed between said first end and said second end, said center section having a channel, said support bar configured to dispose said center section in spaced apart relation to said surface;
an activator arm in pivotal relation with said support bar, said activator arm having a first end, a second end and a center section between said first end and said second end, said activator arm configured to be received in said channel; and
one or more suction cup assemblies, each of said suction cup assemblies having a cup housing, a suction member and a means for disposing said cup housing against said suction member upon pivoting of said activator arm into said channel, said cup housing having a first end attached to said support bar and an open second end disposed outwardly from said support bar, said suction member disposed at said second end of said cup housing and configured to sealably connect to said cup housing so as to define a suction chamber in said cup housing, said disposing means configured to sealably connect said second end of said cup housing and said suction cup member so as to securely attach said shower bar to said surface.

2. The shower bar according to claim 1, wherein said support bar is substantially U-shaped.

3. The shower bar according to claim 1, wherein said support bar has a first end section at said first end and a second end section at said second end, said first end section and said second end section configured to dispose said center section in spaced apart relation to said surface.

4. The shower bar according to claim 3 further comprising at least one of said one or more suction cup assemblies at each of said first end and said second end of said support bar.

5. The shower bar according to claim 4, wherein said disposing means comprises a pivot pin and an activation rod, said pivot pin attached to said activator arm, said activation rod having a first end attached to said pivot pin and a second end attached to said suction cup member, said activation rod configured to sealably connect said section cup member to said second end of said cup housing.

6. The shower bar according to claim 3, wherein said channel extends from said first end to said second end of said support bar through said first end section, said center section and said second end section, said first end of said activator arm at said first end of said support bar and said second end of said activator arm at said second end of said support bar, said activator arm sized and configured to be substantially received in said channel.

7. The shower bar according to claim 1, wherein said disposing means comprises a pivot pin and an activation rod, said pivot pin attached to said activator arm, said activation rod having a first end attached to said pivot pin and a second end attached to said suction cup member, said activation rod configured to sealably connect said section cup member to said second end of said cup housing.

8. The shower bar according to claim 1 further comprising means for releasing said activator arm from said channel so as to release said shower bar from said surface.

9. The shower bar according to claim 8, wherein said releasing means comprises an arm release hole in said support bar.

10. A shower bar for removable attachment to a surface, said shower bar comprising:
a support bar having a first end section at a first end, a second end section at a second end and a center section disposed between said first end section and said second end section, said support bar having a channel extending substantially from said first end to said second end of said support bar, said first end section and said second end section extending outwardly from said center section so as to dispose said center section in spaced apart relation to said surface;
an activator arm in pivotal relation with said support bar, said activator arm having a first end at said first end of said support bar, a second end at said second end of said support bar and a center section between said first end and said second end of said activator arm, said activator arm configured to be received in said channel; and
a suction cup assembly at each of said first end and said second end of said support bar, each of said suction cup assemblies having a cup housing, a suction member and a means for disposing said cup housing against said suction member upon pivoting of said activator arm into said channel, said cup housing having a first end attached to said support bar and an open second end disposed outwardly from said support bar, said suction member disposed at said second end of said cup housing and configured to sealably connect to said cup housing so as to define a suction chamber in said cup housing, said disposing means configured to sealably connect said second end of said cup housing and said suction cup member so as to securely attach said shower bar to said surface.

11. The shower bar according to claim 10, wherein said support bar is substantially U-shaped.

12. The shower bar according to claim 10, wherein said disposing means comprises a pivot pin and an activation rod, said pivot pin attached to said activator arm, said activation rod having a first end attached to said pivot pin and a second end attached to said suction cup member, said activation rod configured to sealably connect said section cup member to said second end of said cup housing.

13. The shower bar according to claim 10 further comprising means for releasing said activator arm from said channel so as to release said shower bar from said surface.

14. The shower bar according to claim 13, wherein said releasing means comprises an arm release hole in said support bar.

15. The shower bar according to claim 10, wherein said channel is generally downwardly facing.

16. A shower bar for removable attachment to a surface, said shower bar comprising:
a support bar having a first end section at a first end, a second end section at a second end and a center section disposed between said first end section and said second end section, said support bar having a channel extending substantially from said first end to said second end of said support bar, said first end section and said second end section extending outwardly from said center section so as to dispose said center section in spaced apart relation to said surface;
an activator arm in pivotal relation with said support bar, said activator arm having a first end at said first end of said support bar, a second end at said second end of said support bar and a center section between said first end and said second end of said activator arm, said activator arm configured to be received in said channel;
a suction cup assembly at each of said first end and said second end of said support bar, each of said suction cup assemblies having a cup housing, a suction member, a pivot pin and an activation rod, said cup housing having a first end attached to said support bar and an open second end disposed outwardly from said support bar, said suction member disposed at said second end of said cup housing and configured to sealably connect to said cup housing so as to define a suction chamber in said cup housing, said pivot pin attached to said activator arm, said activation rod having a first end attached to said pivot pin and a second end attached to said suction cup member, said activation rod configured to sealably connect said section cup member to said second end of said cup housing so as to securely attach said shower bar to said surface; and
means for releasing said activator arm from said channel so as to release said shower bar from said surface.

17. The shower bar according to claim 16, wherein said releasing means comprises an arm release hole in said support bar.

18. The shower bar according to claim 16, wherein said cup housing is integral with said support bar.

19. The shower bar according to claim 16, wherein said channel is generally downwardly facing.
